(19) United States
(12) Patent Application Publication
(10) Pub. No.: US 2016/0094904 A1
(43) Pub. Date: Mar. 31, 2016

(54) In-Ear Earphone

(71) Applicant: INNOVATION SOUND TECHNOLOGY CO., LTD., Guangdong (CN)

(72) Inventor: Shunming Yuen, Hong Kong (CN)

(21) Appl. No.: 14/787,211

(22) PCT Filed: May 8, 2013
(86) PCT No.: PCT/CN2013/075311

§ 371 Date: Oct. 26, 2015

(51) Int. Cl. H04R 1/10; H04R 1/28

(52) U.S. Cl. CPC H04R 1/1016; H04R 1/2876; H04R 2460/11

(57) ABSTRACT

The utility model relates to a canal earphone, comprising an earphone shell and a speaker unit mounted in the earphone shell, the earphone shell forms an earphone front cavity in front of the speaker unit, a vent through hole communicating with the earphone front cavity is opened on the earphone shell, when the earphone is inserted into the ear canal of the user, the superfluous air in the ear canal is discharged to the outside from the earphone and the ear canal through the vent through hole, which shunts one part of the air in the ear canal and the earphone cavity 5.

through the vent through hole, protects the membrane from the deformation under pressure and avoids the earphone from distortion and no sound. Meanwhile, by adjusting the size of the small hole and the damping material adhered to the small hole, the frequency response curve, in particular the low-frequency portion response of the earphone can be adjusted to meet the various listening needs.

### FIELD OF THE INVENTION

The utility model relates to an earphone, in particular to a canal earphone.

### BACKGROUND OF THE INVENTION

Along with economic development and daily improvement of people's living standards, people will often carry various electronic equipment to meet the needs in audio and video entertainment, such as mobile phone, tablet computer or MP3 player. When users of these electronic devices will plug the earphone into the equipment to continue to listen to when being in a noisy environments subway or bus, for example, in addition, the benefit of using the earphone is that others would not be affected. In many types of earphones in the earphone family, the canal earphone is widely popular due to excellent portability, high-quality sound performance and outstanding sound insulation effect. The existing canal earphone is often added with a rubber cover to form a better sound insulation and to get a better degree of tranquility. When the canal earphone sleeved with the rubber cover is plugged into the human ear canal, the surface of the rubber cover and the surface of the ear canal form a tight fit and a seal sound insulation, thus reducing audible noise of the outside world.

However, there is a problem in the existing sealing way via the rubber cover: the rubber cover of the earphone and the ear canal form the seal, so the worn earphone forms a closed pressure field, the vibrating diaphragm of the speaker unit in the earphone will be deformed under pressure, thus leading to problems, voiceless speaker, increased distortion of the earphone and further influencing HIFI performance of the earphone. Meanwhile, the sensitive portion of the user's ear canal will be uncomfortable under pressure, which influences the wearing comfort and is adverse to listen to for a longer time.

Therefore, the technical issue to be urgently solved is developing a canal earphone which can form a good sound insulation and does not produce the pressure filed in the ear canal after being worn.

### CONTENTS OF UTILITY MODEL

The technical issue to be solved in the utility model is: providing a canal earphone which can form a good sound insulation and does not produce the pressure filed in the ear canal after being worn.

The technical solution provided in the utility model for solving the technical issue is: A canal earphone comprises an earphone shell and a speaker unit mounted in the earphone shell, wherein the earphone shell forms an earphone front cavity in front of the speaker unit, a vent through hole communicating with the earphone front cavity is opened on the earphone shell, when the earphone is inserted into the ear canal of the user, the superfluous air in the ear canal is discharged to the outside from the earphone and the ear canal through the vent through hole.

Furthermore, the front end of the earphone shell is provided with a sound guide tube communicating with the earphone front cavity in a convex way, an annular slot is arranged along the circumferential direction of the outer surface of the sound guide tube in a concave way, the vent through hole is opened on the bottom surface of the annular slot.

Furthermore, the front end of the earphone shell is provided with a sound guide tube communicating with the earphone front cavity in a convex way, an annular slot is arranged along the circumferential direction of the outer surface of the sound guide tube in a concave way, the outlet of the vent through hole is opened on the joint of the bottom surface of the annular slot and the slot shoulder of the annular slot, a groove communicating with the outlet is opened on the slot shoulder in a penetration way.

Furthermore, the vent through hole is the stepped hole, the stepped hole consists of the sequentially connected contracted section and expanded section, the outlet arranged on the joint of the bottom surface and the slot shoulder is the outlet of the expanded section of the stepped hole.

Furthermore, the vent through hole is opened on the cavity wall of the earphone front cavity.

Furthermore, the vent through hole respectively have the inlet and outlet correspondingly arranged on the inner wall of the sound guide tube and the bottom surface of the annular slot, the inlet and/or outlet is adhered with the damping material.

Furthermore, the diameter of the vent through hole is in the range of 0.16 mm-0.8 mm

Furthermore, the caliber of the outlet is in the range of 0.13 mm-0 15 mm

Furthermore, the aperture of the vent through hole is 0.8 mm, and the air permeability of the damping material is 70 L/m2.s-2500 L/m2.s.

Furthermore, the damping material is sound mixing paper.

The advantages of the utility model are:

In the utility model, the earphone shunts one part of the air in the ear canal and the earphone cavity through the vent through hole by opening the vent through hole on the earphone shell, which protects the membrane from the deformation under pressure and avoids the earphone from distortion and no sound. Meanwhile, by adjusting the size of the small hole and the damping material adhered to the small hole, the frequency response curve, in particular the low-frequency portion response of the earphone can be adjusted so as to meet the various listening needs.

### BRIEF INTRODUCTION OF THE DRAWINGS

In combination with the drawings, the canal earphone of the utility model is further described.

FIG. 1 is the structural schematic view of the canal earphone in embodiment 1.

FIG. 2 is the front view of the canal earphone in FIG. 1

FIG. 3 is frequency response curve change schematic view when the canal earphone in embodiment 1 has different aperture of vent through hole.

FIG. 4 is the structural schematic view of the canal earphone in embodiment 2.

FIG. 5 is the frequency response curve change schematic view when the vent through hole of the canal earphone in embodiment 2 is adhered to sound mixing paper with different air permeability. In the utility model, the earphone shunts one part of the air in the ear canal and the earphone cavity

FIG. 6 is the structural schematic view of the sound guide tube of the canal earphone in embodiment 3.

FIG. 7 is the structural schematic view of the canal earphone in embodiment 4.

### DETAILED DESCRIPTION OF THE PREFERRED EMBODIMENTS

### Embodiment 1

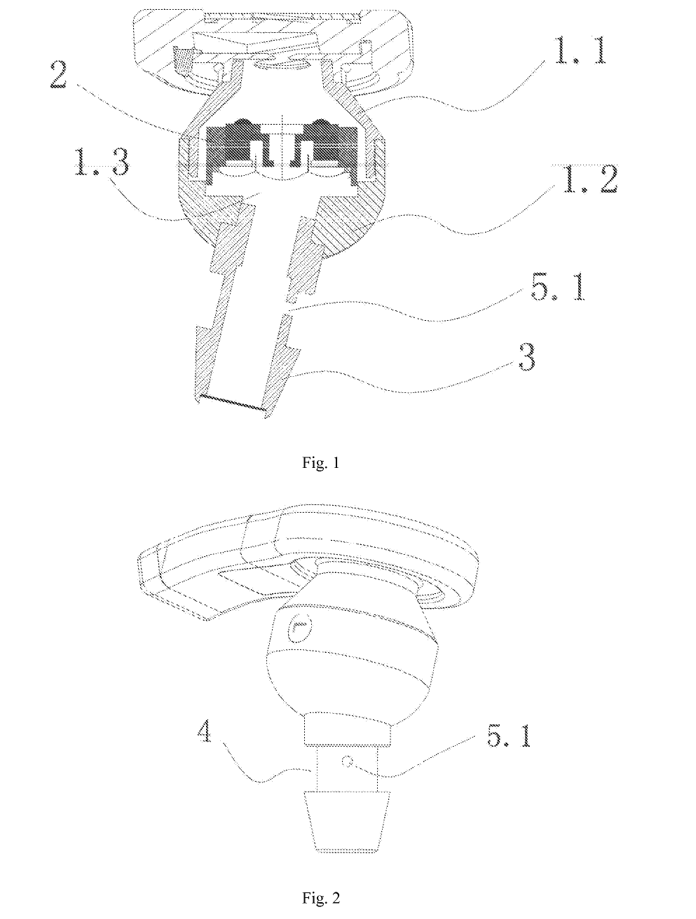

As shown in FIG. 1 and FIG. 2, the canal earphone comprises an earphone shell and a speaker unit 2 mounted in the earphone shell.

Wherein, the earphone shell is formed by assembling the earphone rear shell 1.1 and the earphone front shell 1.2 in an involution way. The earphone shell is a hollow structure, an annular speaker unit fixing ring is provided on the joint of the earphone rear shell 1.1 and the earphone front shell 1.2 along the circumferential direction of the inner wall of the earphone front shell 1.2.

The edge of the speaker unit 2 is connected with the speaker unit fixing ring, the speaker unit 2 is mounted in the earphone shell in the form of the vibrating diaphragm.

The earphone shell forms an earphone front cavity 1.3 in front of the speaker unit, the earphone front cavity 1.3 is formed of the earphone front shell 1.2 that is inwards depressed in front of the vibrating diaphragm of the speaker unit 2, different shape of the earphone front cavity 1.3 can form different tone of the earphone.

The front end of the earphone shell is provided with a sound guide tube 3 communicating with the earphone front cavity 1.3 in a convex way. The sound guide tube also participates in and forms the reflection of sound, so the sound guide tube 3 is one part of the earphone shell. An annular slot 4 is arranged along the circumferential direction of the outer surface of the sound guide tube 3 in a concave way. The purpose of providing the annular slot is: a rubber cover can be sleeved on the sound guide tube 3 in use to improve the wring fastness in the ear canal and strengthen the sound insulation effect.

In the embodiment, a vent through hole 5.1 which is 0.16 mm in diameter is opened on the bottom surface of the annular slot 4. The vent through hole penetrates the wall of the sound guide tube 3, and the vent through hole can communicate with the earphone front cavity 1.3 through the passage in the sound guide tube 3. The vent through hole 5.1 is provided with the inlet and outlet correspondingly arranged on the inner wall of the sound guide tube 3 and the bottom surface of the annular slot 4. The superfluous air in the ear canal can be discharged to the outside from the inside of the earphone and ear canal through the vent through hole when the earphone is plugged in the user's ear canal.

Opening the vent through hole 5.1 on the earphone shell may change the acoustic structure of the earphone and influence the reflection propagation of the sound in the earphone inside, and lead to the partial leakage of the sound energy, thus obviously reducing the loudness of low frequency band. Then, opening the vent through hole 5.1 on the earphone shell not only prevents the vibrating diaphragm from deformation under pressure but also dedicatedly improve and adjust the problem that the bass of the canal earphone is easily mixed, chaotic and muffled, so the acoustic sense of the sound tends to be more natural and relaxed to meet different types of music.

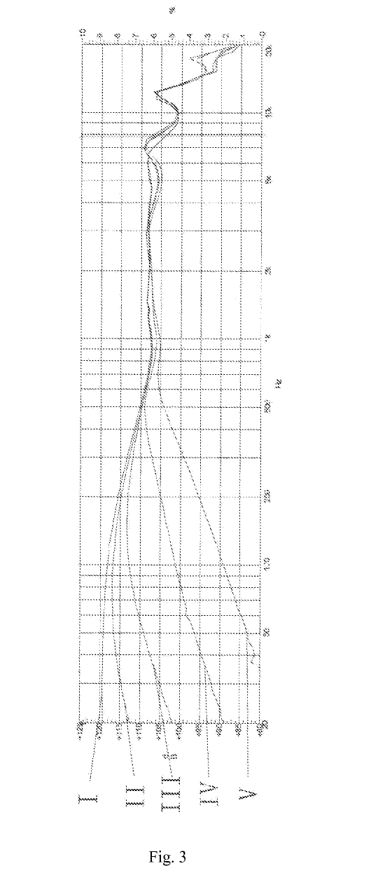

As shown in FIG. 3, curve I is the measured earphone frequency response curve of the traditional canal earphone without opening the vent through hole 5.1; curve II is the measured earphone frequency response curve of the canal earphone of the utility model (the sound guide tube 3 is provided with the vent through hole with the aperture of 0.16 mm) After comparing the earphone frequency response curve I and II, the following conclusion can be found: the soundness of the canal earphone of the utility model at the low frequency point of 20 Hz is about 6 db lower than the soundness of the traditional canal earphone, thus opening the vent through hole on the earphone shell can solve the problem that the bass of the canal earphone is easily mixed, chaotic and muffled to a certain degree.

Based on the technical solution mentioned above, it is easy to know that the vent through holes 5.1 with different size of aperture will produce different regulating effects to the earphone low frequency band. For this reason, the inventor has different try and makes multiple test on the aperture of the vent through hole 5.1 and separately measures multiple earphone frequency response curves corresponding to different apertures in the case of only changing the size of the vent through hole 5.1:

1) As shown in FIG. 3, when the diameter of the vent through hole is 5.1 is 0.3 mm, the earphone frequency response corresponds to curve III, the soundness of the earphone at the low frequency point of 20 Hz is 101.5 db, which is about 18 db lower than the soundness of the traditional canal earphone at the same frequency so as to further solves the problem that the bass of the canal earphone is easily mixed, chaotic and muffled;

2) As shown in FIG. 3, when the diameter of the vent through hole is 5.1 is 0.5 mm, the earphone frequency response corresponds to curve IV, the soundness of the earphone at the low frequency point of 20 Hz is 89 db, which is about 30 db lower than the soundness of the traditional canal earphone at the same frequency so as to further solves the problem that the bass of the canal earphone is easily mixed, chaotic and muffled;

3) As shown in FIG. 3, when the diameter of the vent through hole is 5.1 is 0.8 mm, the earphone frequency response corresponds to curve V, the soundness of the earphone at the low frequency point of 20 Hz is lower than 80 db, the soundness of the earphone at the low frequency band is lower at the moment. There is no problem that the bass of the canal earphone is easily mixed, chaotic and muffled, but the index in the intuitive acoustic sense about ‘three-frequency equilibrium’ is approaching the lowest point of the public acceptability during the listening process.

Therefore, the vent through hole 5.1 opened on the sound guide tube 3 of the canal earphone in the embodiment is 0.16 mm-0 8 mm in diameter.

### Embodiment 2

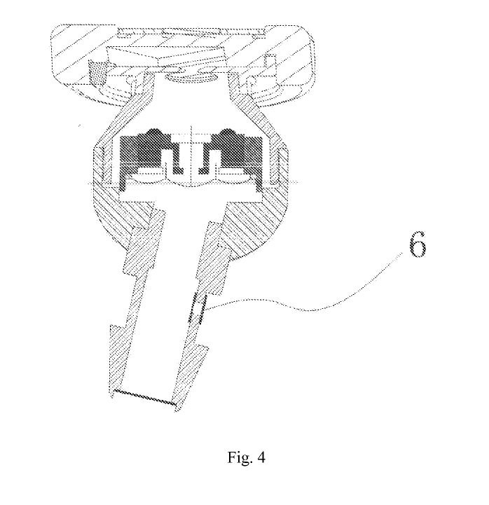

The embodiment is an improvement based on Embodiment 1, for the convenience, users can adjust the channel of the earphone according to their listening habits, as shown in FIG. 4. As for the canal earphone in the embodiment, the inlet and/or outlet of the vent through hole 5.1 is adhered with sound mixing paper 6 with different air permeability to change the characteristics of the earphone sound (obviously, sound mixing paper 6 can be replaced with the damping material, such as fiber woven cloth).

The aperture of the vent through hole 5.1 in the embodiment is 0.8 mm, the inlet and/or outlet of the vent through hole 5.1 is adhered with sound mixing paper 6 with air permeability.

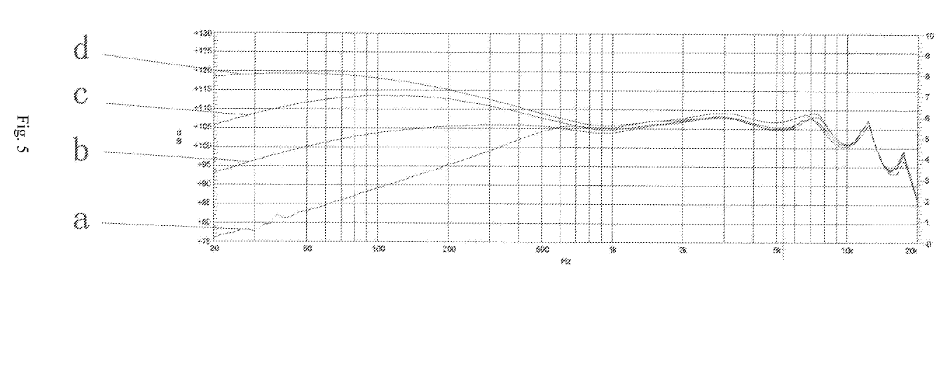

The inventor have different try on the air permeability of sound mixing paper 6, as shown in FIG. 5, the vent through hole 5.1 will produce different earphone frequency response curve when being adhered with sound mixing paper 6 with different air permeability.

1) when the inlet and/or outlet of the vent through hole 5.1 is not adhered with sound mixing paper 6 (the air permeability of the vent through hole is equivalent to the total air permeability of sound mixing paper 6), the corresponding earphone frequency response curve is the curve a as shown in FIG. 5;

2) when the total air permeability of sound mixing paper 6 adhered to the inlet and/or outlet of the vent through hole 5.1 is 2500 L/m2.s, the corresponding earphone frequency response curve is the curve b as shown in FIG. 5;

3) when the total air permeability of sound mixing paper 6 adhered to the inlet and/or outlet of the vent through hole 5.1 is 900 L/m2.s, the corresponding earphone frequency response curve is the curve c as shown in FIG. 5;

4) when the total air permeability of sound mixing paper 6 adhered to the inlet and/or outlet of the vent through hole 5.1 is 70 L/m2.s, the corresponding earphone frequency response curve is the curve d as shown in FIG. 5, the air permeability of the vent through hole is tiny, the earphone is similar to the traditional earphone in sound characteristics.

Therefore, the total air permeability of sound mixing paper 6 adhered to the inlet and/or outlet of the vent through hole 5.1 is in the range of 70 L/m2.s-2500 L/m2.s so as to variously regulate the earphone sound.

### Embodiment 3

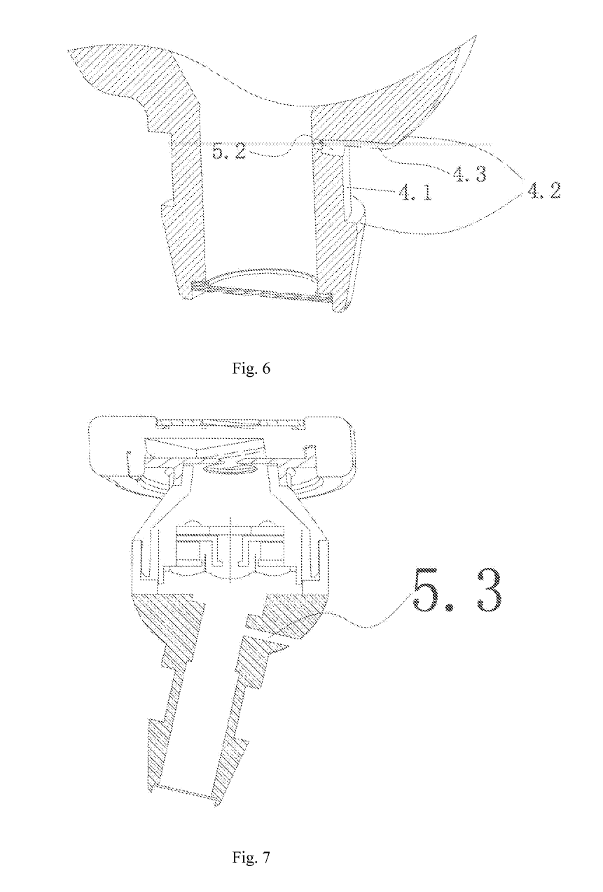

As shown in FIG. 6, two sides of the annular slot bottom surface 4.1 are annular slot shoulders 4.2, the embodiment is the improvement based on embodiment 1: the vent through hole 5.2 is opened on the joint of the annular slot shoulders 4.2 and the annular slot bottom surface 4.1, the outlet of the vent through hole 5.2 is also opened on the joint of the annular slot bottom surface 4.1 and the annular slot shoulders 4.2, and a slot 4.3 communicating with the outlet is opened on the annular slot shoulders 4.2 in a penetration way.

To prevent the jamming of the outlet, the vent through hole 5.2 is the stepped hole formed of the sequentially connected contracted section and expanded section, the outlet opened on the joint of the annular slot bottom surface 4.1 and the annular slot shoulders 4.2 is the outlet of the expanded section of the stepped hole (or the stepped hole is replaced with the cylindrical through hole with the consistent diameter at the front and rear side).

The caliber of the outlet is in the range of 0.13 mm-0.15 mm

In Embodiment 1, after the annular slot 4 is sleeved with the rubber cover, the rubber cover may jam and seal the outlet of the vent through hole 5.1 on the annular slot bottom surface and impede the outlet from normal ventilation.

In the embodiments, the vent through hole 5.2 is opened on the joint of the annular slot shoulders 4.2 and the annular slot bottom surface 4.1, the vent through hole 5.2 has an outlet partially located on the annular slot bottom surface 4.1 and partially located on the annular slot shoulders 4.2. Even if the rubber cover jams the part of the outlet of the vent through hole 5.2 on the annular slot bottom surface 4.1, the part of the outlet of the vent through hole 5.2 on the annular slot shoulders 4.2 can still be matched with the penetrated opening 4.3 to ventilate. Therefore, after sleeving the rubber cover, it is unnecessary to consider the problem whether the rubber cover will cause the jam of the vent through hole 5.2, thus improving the using effect.

### Embodiment 4

As shown in FIG. 7, the difference of the embodiment from embodiment 1 is: the vent through hole 5.3 is opened on the wall of the earphone front cavity 1.3.

The utility model is not limited to the embodiments described above, any technical solution using the equivalent replacement is to be embraced within the scope of protection of the utility model.

1. A canal earphone, comprising an earphone shell and a speaker unit mounted in the earphone shell, wherein the earphone shell forms an earphone front cavity in front of the speaker unit, a vent through hole communicating with the earphone front cavity is opened on the earphone shell, when the earphone is inserted into the ear canal of the user, the superfluous air in the ear canal is discharged to the outside from the earphone and the ear canal through the vent through hole.

2. The canal earphone as claimed in claim 1, wherein the front end of the earphone shell is provided with a sound guide tube communicating with the earphone front cavity in a convex way, an annular slot is arranged along the circumferential direction of the outer surface of the sound guide tube in a concave way, the vent through hole is opened on the bottom surface of the annular slot.

3. The canal earphone as claimed in claim 1, wherein the front end of the earphone shell is provided with a sound guide tube communicating with the earphone front cavity in a convex way, an annular slot is arranged along the circumferential direction of the outer surface of the sound guide tube in a concave way, the outlet of the vent through hole is opened on the joint of the bottom surface of the annular slot and the slot shoulder of the annular slot, a groove communicating with the outlet is opened on the slot shoulder in a penetration way.

4. The canal earphone as claimed in claim 1, wherein the vent through hole is the stepped hole, the stepped hole consists of the sequentially connected contracted section and expanded section, the outlet arranged on the joint of the bottom surface and the slot shoulder is the outlet of the expanded section of the stepped hole.

5. The canal earphone as claimed in claim 1, wherein the vent through hole is opened on the cavity wall of the earphone front cavity.

6. The canal earphone as claimed in claim 2, wherein the vent through hole respectively have the inlet and outlet correspondingly arranged on the inner wall of the sound guide tube and the bottom surface of the annular slot, the inlet and/or outlet is adhered with the damping material.

7. The canal earphone as claimed in claim 2, wherein the diameter of the vent through hole is in the range of 0.16 mm-0.8 mm.

8. The canal earphone as claimed in claim 3, wherein the caliber of the outlet is in the range of 0.13 mm-0.15 mm.

9. The canal earphone as claimed in claim 6, wherein the aperture of the vent through hole is 0.8 mm, the air permeability of the damping material is 70 L/m2.s-2500 L/m2.s.

10. The canal earphone as claimed in claim 6, wherein the damping material is sound mixing paper.
